(19) United States
(12) Patent Application Publication
(10) Pub. No.: US 2020/0068685 A1
(43) Pub. Date: Feb. 27, 2020

(54) Universal Translator And Accessory Interface System For Luminaires

(71) Applicant: Eaton Intelligent Power Limited, Dublin (IE)

(72) Inventors: Eric DiFelice, Aurora, CO (US); William E. Getzinger, Golden, CO (US); Derek Hudson, Aurora, CO (US); Chris M. Clary, Broomfield, CO (US); Nicole M. Davis, Denver, CO (US); J.T. Brlansky, Denver, CO (US)

(21) Appl. No.: 16/551,512

(22) Filed: Aug. 26, 2019

Related U.S. Application Data
(60) Provisional application No. 62/723,357, filed on Aug. 27, 2018.

(51) Int. Cl. H05B 37/02; H05B 33/08; F21V 33/00; G10L 15/00; G10L 15/22

(52) U.S. Cl. CPC H05B 37/0236; H05B 33/0884; G10L 2015/223; G10L 15/005; G10L 15/22; F21V 33/0056

(57) ABSTRACT

A luminaire may include a universal translator and interface system. The universal translator and interface system may include one or more universal interfaces that are configured to removably and communicably couple one or more control devices and/or a building lighting control system to the luminaire. Further, the universal translator and interface system may include a universal translator engine that is communicably coupled to the one or more universal interfaces. The universal translator engine is configured to translate data in a first format associated with a first communication protocol to a second format associated with a second communication protocol to enable interoperability between the control devices, the building lighting control system, and the luminaire that may have different communication protocols that are incompatible with each other.

### RELATED APPLICATIONS

The present application claims priority to U.S. Provisional Patent Application No. 62/723,357 filed Aug. 27, 2018 and titled “Universal Translator and Accessory Interface System for Luminaires.” The entire contents of the foregoing application are hereby incorporated herein by reference.

### TECHNICAL FIELD

Embodiments of the present disclosure relate generally to lighting systems, and more particularly to a universal translator and accessory interface system for luminaires.

### BACKGROUND

The low cost of microprocessors and electronics combined with the rise in the Internet of Things (IoT) have led the lighting industry to move towards “smart” lighting systems where luminaires include one or more control devices installed therein to improve the efficiency of the luminaires and/or add functions to the luminaires. For example, smart lighting system luminaires may include various sensors, building control systems, network devices, etc., that are coupled thereto and collect information of users and/or the environment, adjust the operation of the luminaires based on the collected information, communicate the collected information with other luminaires or a central (or remote) control system, etc.

In existing smart lighting systems, the luminaires, the control devices coupled to the luminaires, and the control systems (e.g., building lighting control systems) that control the luminaires may all need to have the same communication protocol to operate with each other. If a luminaire is to operate with a control device having a communication protocol that is incompatible with or different from that of a luminaire, the driver associated with the luminaire may have to be changed to one that is compatible with the communication protocol of the control device. In another example, to change an existing lighting control system of a building to a new lighting control system, all the luminaires that were previously controlled by the existing lighting control system may need to be changed or modified to match the communication protocol of the new lighting control system for proper operation. As seen in the above mentioned examples, in existing smart lighting systems, inter-operation between control devices, control systems, and luminaires having different communication protocols requires significant changes to the luminaires, control devices, and/or the control systems. Said changes may require a distributor, manufacturer, and/or installer to maintain a stock of hundreds of different drivers (e.g., LED drivers) and/or control devices of different communication protocols. Supporting all of the luminaire drivers and/or control devices associated with different communication protocols and controls results in a high degree of stock keeping unit (SKU) complexity and may have a large impact on inventory.

Further, in existing luminaires, the control devices are typically integrated into the luminaires. For example, the control devices, such as sensors, cameras, etc., may be attached to the luminaires using fasteners and connected to wires in the luminaires to supply power to and/or enable data communication with the control devices. Integrating the control devices into the luminaires may limit the modularity, i.e., the ability to remove, replace, or add-on other control devices to the existing luminaires without having to either replace the whole luminaire or disassembling the luminaires.

This background information is provided to reveal information believed to be of possible relevance to the present disclosure. No admission is necessarily intended, nor should be construed, that any of the preceding information constitutes prior art against the present disclosure.

### SUMMARY

In one aspect, the present disclosure relates to a luminaire that comprises a universal interface that is configured to removably and communicably couple a control device to the luminaire. Further, the luminaire includes a universal translator engine that is communicably coupled to a lighting control system of the luminaire. The universal translator engine is configured to transform input data that is received from the control device and associated with a first communication protocol to an output data that is compatible with the lighting control system and associated with a second communication protocol to enable communication between the control device and the lighting control system. The first communication protocol is different from the second communication protocol.

In another aspect, the present disclosure relates to a luminaire that includes a first universal interface that is configured to removably and communicably couple a control device to the luminaire. Further, the luminaire includes a second universal interface that is configured to removably and communicably couple a lighting control system to the luminaire. Furthermore, the luminaire includes a universal translator engine that is communicably coupled to the first universal interface and the second universal interface. Additionally, the luminaire includes a power control device that is coupled to the universal translator engine, and a light source that is coupled to the power control device. The power control device is configured to regulate and supply operational power to the light source and the universal translator engine. The universal translator engine is configured to transform input data that is received from the control device and associated with a first communication protocol to an output data that is compatible with the lighting control system and associated with a second communication protocol to enable communication between the control device and the lighting control system. The first communication protocol is different from the second communication protocol.

These and other aspects, features, and embodiments of the disclosure will become apparent to a person of ordinary skill in the art upon consideration of the following brief description of the figures and detailed description of illustrated embodiments.

### BRIEF DESCRIPTION OF THE FIGURES

The foregoing and other features and aspects of the present disclosure are best understood with reference to the following description of certain example embodiments, when read in conjunction with the accompanying drawings, wherein:

FIG. 1 illustrates an example luminaire including a universal translator and accessory interface system, in accordance with example embodiments of the present disclosure;

FIG. 2 illustrates a block diagram of the universal translator engine of the universal translator and accessory interface system of FIG. 1, in accordance with example embodiments of the present disclosure;

FIG. 3 illustrates a perspective view of an example luminaire including a universal translator engine and universal interfaces integrated with the universal translator, in accordance with example embodiments of the present disclosure;

FIG. 4 illustrates another perspective view of the example luminaire of FIG. 3, in accordance with example embodiments of the present disclosure;

FIG. 5 illustrates a top view of another example luminaire including an audio transducer coupled to the luminaire via a universal interface, in accordance with example embodiments of the present disclosure;

FIGS. 6-8 illustrate different views of yet another example luminaire with control devices coupled thereto via universal interfaces, in accordance with example embodiments of the present disclosure; and

FIG. 9 is a flowchart that illustrates an example algorithm or example method associated with the universal translator engine of the universal translator and accessory interface system in FIG. 1, in accordance with example embodiments of the present disclosure.

The drawings illustrate only example embodiments of the present disclosure and are therefore not to be considered limiting of its scope, as the present disclosure may admit to other equally effective embodiments. The elements and features shown in the drawings are not necessarily to scale, emphasis is instead placed on clearly illustrating the principles of the example embodiments. Additionally, certain dimensions or positions may be exaggerated to help visually convey such principles.

### DETAILED DESCRIPTION OF EXAMPLE EMBODIMENTS

The present disclosure describes a universal translator and accessory interface system for luminaires. The universal translator and accessory interface system enables interoperability between luminaire drivers, control devices, and/or building lighting control systems that have different communication protocols. That is, the universal translator and accessory interface system allows control devices, building lighting control systems, and luminaire drivers to operate with each other while having different communication protocols that are typically not compatible with each other. Further, the universal translator and accessory interface system provides modularity to the luminaire in that it allows the control devices to be field installable and/or replaceable by an end user without the need for replacing and/or disassembling the luminaire. Furthermore, the universal translator and accessory interface system allows data processing hardware to be moved from the control devices to the luminaire, thereby enabling a reduction in the size or footprint of the control devices.

An example luminaire with a universal translator and accessory interface system may include a universal translator engine and universal interfaces that are disposed in the luminaire. In particular, the universal interfaces may be configured to allow one or more control devices to be removably and communicably coupled to the luminaire. The universal interfaces may be communicably coupled to the universal translator engine to transmit data from the control devices to the universal translator engine and transmit data from the universal translator engine to the control devices. In addition to being coupled to the universal interfaces, the universal translator engine may be communicably coupled to a building lighting control system associated with the luminaire for receiving data therefrom and transmitting data thereto. Further, the universal translator engine may be electrically and communicably coupled to a power control device, such as an LED driver associated with the luminaire to receive operational power and to transmit and receive data therefrom.

The universal translator engine may be configured to convert or translate between different communication protocols. That is, the universal translator engine may be configured to transform input data that is in a first format associated with a first communication protocol to an output data that is in a second format associated with a second communication protocol, which in turn enables communication between the power control device, the control devices, and/or the building lighting control system having different communication protocols. For example, the universal translator engine may be configured to transform data that is received from the control devices and/or the power control device of the luminaire to a format that is compatible with a communication protocol of the building lighting control system and vice-versa, thereby enabling communication between the control devices, the power control device, and the building lighting control system that may have different communication protocols. In some examples, the universal translator engine enables communication between two or more control devices that are coupled to the luminaire and that have different communication protocols.

In the following paragraphs, a universal translator and accessory interface system will be described in further detail by way of examples with reference to the attached drawings. In the description, well-known components, methods, and/or processing techniques are omitted or are briefly described so as not to obscure the disclosure. As used herein, the “present disclosure” refers to any one of the embodiments of the disclosure described herein and any equivalents. Furthermore, reference to various feature(s) of the “present disclosure” is not to suggest that all embodiments must include the referenced feature(s).

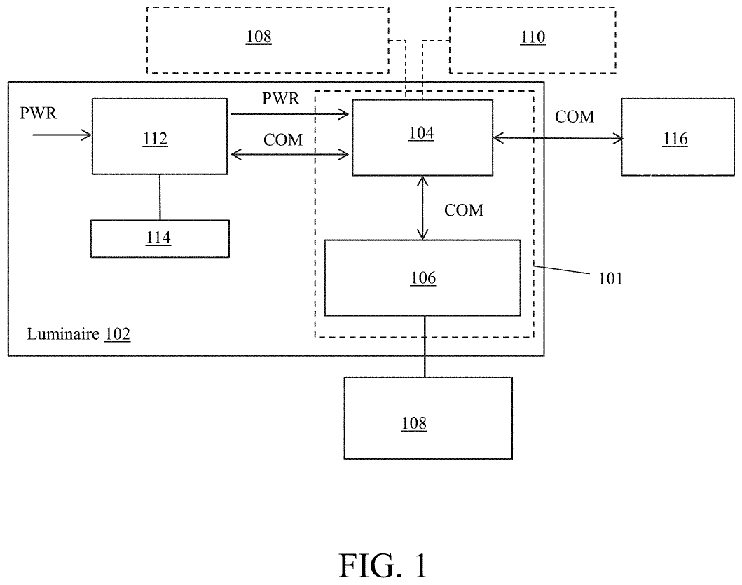

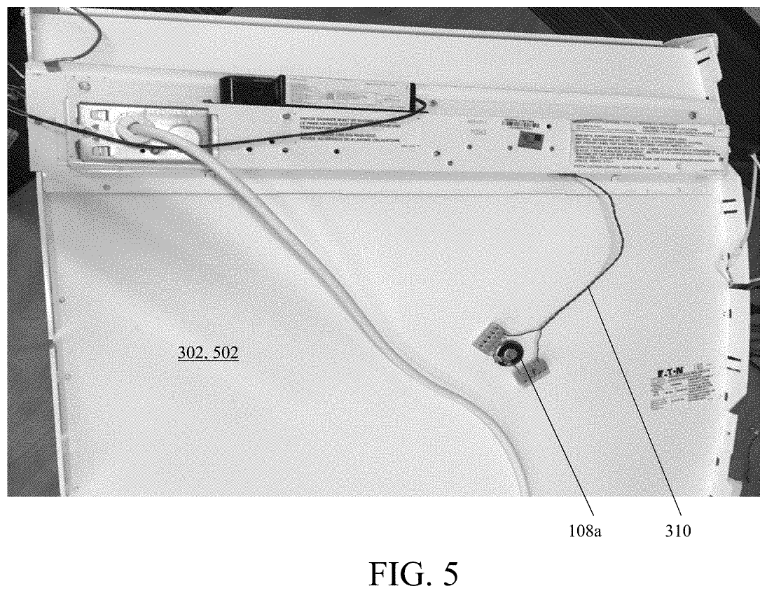

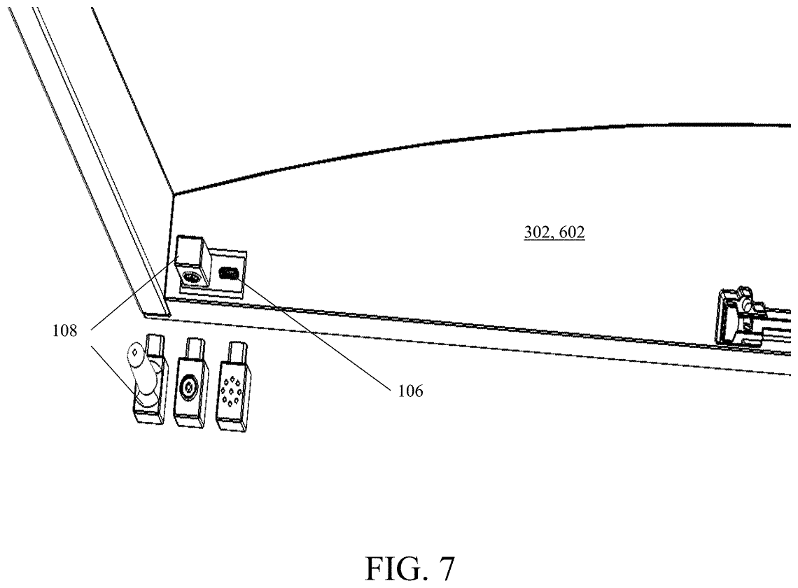

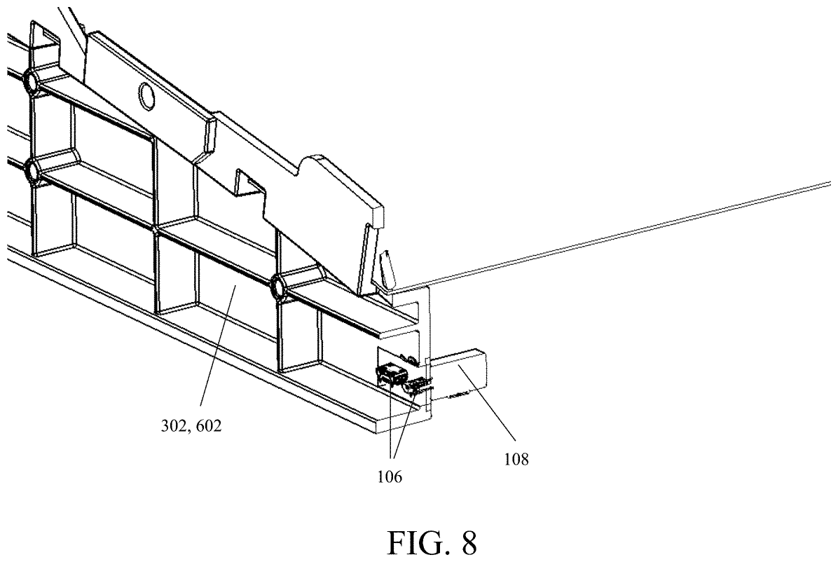

In particular, example embodiments of the universal translator and accessory interface system of the present disclosure will be described in association with FIGS. 1-9. Referring to FIG. 1, an example luminaire 102 may include a light source 114 and a power control device 112 that is configured to drive or control the power (e.g., regulate power) delivered to the light source 114. The power control device 112 may be coupled to an external power source and configured to receive power therefrom. Further, the power control device 112 may be electrically coupled to the light source 114 to provide regulated power to the light source 114. Furthermore, the power control device 112 may be electrically and communicably coupled to the universal translator engine 104 to provide power to the universal translator engine 104 and to transmit and receive data from the universal translator engine 104. In some example embodiments, the power control device 112 may be coupled to the universal translator engine 104 either using electrical conductors or wirelessly.

In one example, the light source 114 may include a light emitting diode or an array of light emitting diodes, and the power control device 112 may include an LED driver. However, in other example embodiments, the luminaire 102 may include any other appropriate light source 114, such as a halogen lamp, fluorescent lamps, etc., and any other appropriate power control device 112 corresponding to the light source 114 without departing from a broader scope of the present disclosure.

In addition to the power control device 112 and the light source 114, the luminaire 102 may include a universal translator and accessory interface system 101. In particular, the universal translator and accessory interface system 101 may include one or more universal accessory interfaces 106 (hereinafter ‘universal interfaces’), where each universal interface 106 is configured to removably and communicably couple a control device 108 to the luminaire 102. In one or more example embodiments, when the control devices 108 are not plugged into the universal interfaces 106 of the luminaire 102, the universal interfaces 106 may be covered using interface cover members (not shown in Figures) to conceal the universal interfaces for aesthetic appeal and to prevent any damages from environmental elements, such as dust, water, etc.

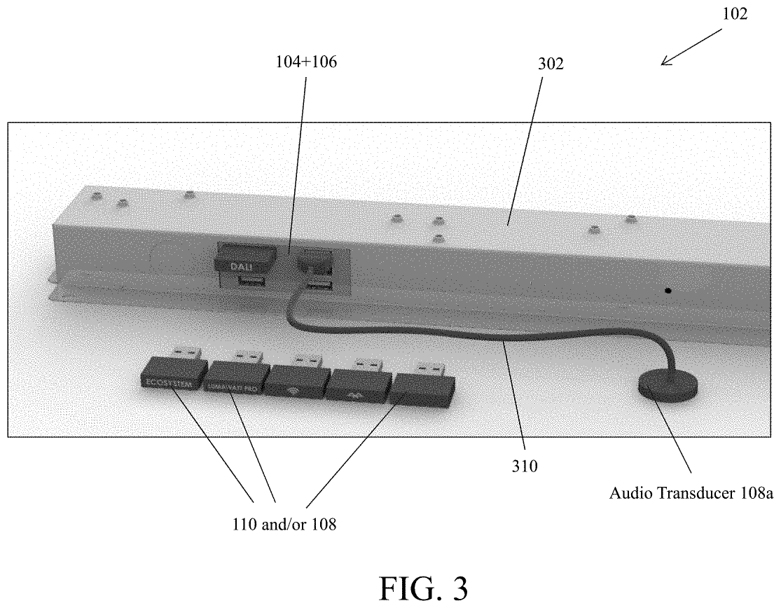

As illustrated in FIGS. 3-4 and 6-8, in one example, the universal interface 106 may include a micro-USB port or receptacle (female) that is configured to receive a micro-USB connector end (male) of a control device 108. Alternatively, in other example embodiments, the universal interface 106 may include the connector end (male) and the control devices 108 may include the port or receptacle (female). However, in other example embodiments, the universal interface 106 may include any other appropriate coupling port or receptacle, such as a USB port, HDMI port, USB Type-C, Firewire, or any other appropriate ports associated with ubiquitously available connectors that allow data transfer between the luminaire 102 and the control device 108. In some example embodiments, the universal interfaces 106 may also be configured to transfer power to the control devices 108 that are coupled thereto. In said example embodiments where the universal interfaces 106 are configured to transfer power to the control devices 108 coupled thereto, the universal interfaces 106 may be electrically coupled to the power control device 112 to receive power therefrom and transfer said power to the control devices 108.

As illustrated in FIG. 1, the universal interfaces 106 may be communicably coupled to the universal translator engine 104 and configured to transfer data from the control devices 108 to the universal translator engine 104 and vice-versa. The data that is transferred between the control devices 108 and the universal translator engine 104 may be digital or analog data. In some example embodiments, in addition to transferring data between the control devices 108 and the universal translator engine 104, the universal interfaces 106 may include built in processing capability and may be configured to process and/or condition data received from the control devices 108 prior to transmitting the data to the universal translator engine 104 and vice-versa. For example, in some embodiments, the universal interface 106 may include an analog to digital converter and/or a digital to analog converter. In some example embodiments, some of the data processing associated with the control devices 108 may be moved to the universal interfaces 106. Alternatively, all data processing and conditioning may be done at the universal translator engine 104 and the universal interfaces 106 may not include any data processing capability. In either case, moving the data processing associated with the control devices 108 to the universal translator and accessory interface system 101 of the luminaire 102, i.e., the universal translator engine 104 and/or the universal interfaces 106, allows data processing related hardware to be removed from the control devices which in turn results in a reduction in size of the control devices 108.

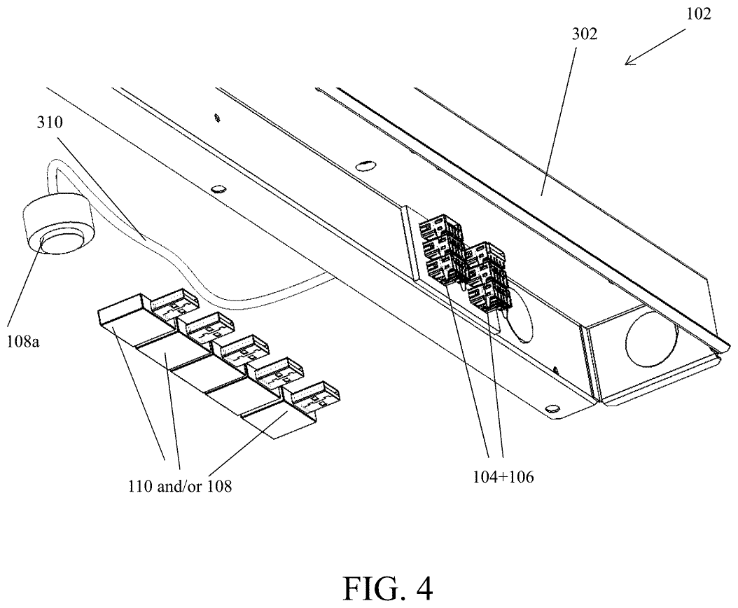

In some example embodiments, as illustrated in FIGS. 1 and 6-8, the universal interfaces 106 may be located remote from the universal translator engine 104 and may be coupled to the universal translator engine 104 either using wires or wirelessly. However, in other example embodiments, as illustrated in FIGS. 3-4, in addition to or as an alternative to the remotely located universal interfaces, the luminaire 102 may include universal interfaces 106 that are integrated with the universal translator engine 104 such that the universal translator engine 104 and the universal interfaces 106 form a single component. In yet another example embodiment, the universal translator engine 104 and the universal interfaces 106 may be integrated into the power control device 112 without departing from a broader scope of the present disclosure. Similarly, in some example embodiments, the control devices 108 may be directly plugged into the universal interfaces 106, while in other example embodiments, the control devices 108 may be located remotely from the luminaire 102 and coupled to the universal interfaces 106 using electrical conductors, such as electrical wires. For example, as illustrated in FIGS. 3-5, an audio transducer 108a may be disposed on a housing 302 of the luminaire 102 and coupled to the universal interface 106 using wires or cables 310.

In one example embodiment, all the universal interfaces 106 in the luminaire 102 may be of the same type, e.g., micro-USB interfaces. However, in some example embodiments, the luminaire 102 may have different types of universal interfaces 106. For example, the luminaire 102 may include an array of universal interfaces 106, where a first set of the array of universal interfaces may be of a first type, e.g., micro-USB interfaces, a second set of the array of universal interfaces may be of a second type, e.g., Firewire, a third set of the array of universal interfaces may be of a third type, e.g., Thunderbold interfaces.

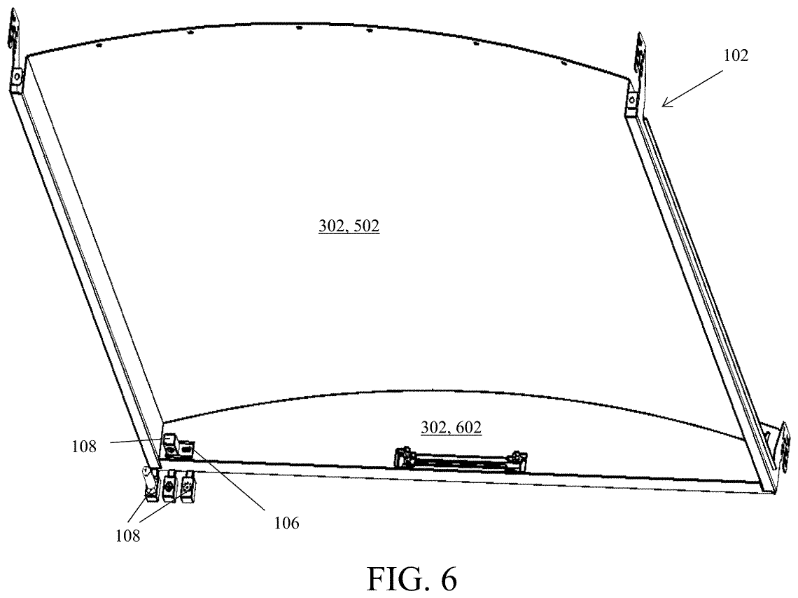

The universal interfaces 106 may be disposed on any portion of the luminaire 102 that is readily and easily accessible to an end user to provide ease of installation or coupling of the control devices 108 to the luminaire 102. For example, as illustrated in FIGS. 6-8, the universal interfaces 106 may be disposed in a room facing portion of an end plate 602 of the luminaire 102 such that it is easily accessible to an end user after installation of the luminaire 102. Alternatively or in addition to the universal interfaces 106 disposed in the room facing portion of the luminaire 102, in some example embodiments, as illustrated in FIGS. 3-4, the universal interfaces 106 may be disposed in the plenum or ceiling facing portion of the housing 302 of the luminaire 102.

As illustrated in FIG. 1, the control devices 108 may include, but are not limited to, a sensor, camera, microphone, visual indicator, antenna, LiFi transmitter/receiver, AR module, etc. In other words, the control devices 108 may include any appropriate electrical or electronic device that is configured to collect any appropriate data associated with the luminaire 102 and/or an environment surrounding the luminaire 102, and/or transmit data from the luminaire 102 in visual, auditory, tactile form through a wired or wireless transmission mechanism. For example, as illustrated in FIGS. 1 and 3-5, the control devices 108 may include an audio transducer 108a that is configured to operate as a speaker system. A typical speaker system may include a cone and a magnet structure that vibrates the cone to generate sound waves. The audio transducer 108a that is illustrated in FIGS. 3-5 and used with the luminaire 102 may include the magnet structure. However, instead of using the cone, the magnet structure of the audio transducer 108a may be disposed on a surface of the luminaire 102, such as on a reflector surface 502 of the luminaire 102. The magnet structure may create vibrations on the luminaire surface to generate sound waves, which in turn results in the luminaire 102 operating as a speaker system to transmit data to an end user in auditory form. For example, using the audio transducer 108a, the luminaire 102 may be used to play music. In another example, a microphone (shown in FIG. 1) coupled to the luminaire 102 may receive voice commands from the end user and may communicate back with the end user through the audio transducer 108a to form a smart speaker system like Amazon Echo, Google Home, etc. In said example, the luminaire 102 may have Internet connectivity.

As illustrated in FIG. 1, the universal translator engine 104 may be communicably coupled to the lighting control system 116 and the control devices 108 through universal interfaces 106 that are integrated into the universal translator engine 104. The universal translator engine 104 may be configured to receive data from and transmit data to the lighting control system 116 and the control devices 108. In one example embodiment, the lighting control system 116 may include a building lighting control system that is configured to control the luminaires disposed in a building. The building lighting control systems may include, but are not limited to, Digital Addressable Lighting Interface (DALI), EcoSystem, Enlighted, etc. However, in other example embodiments, the lighting control system 116 may include control systems that are configured to control one or more luminaires in a room, or luminaires disposed in a zone, etc., without departing from a broader scope of the present disclosure.

Further, the universal translator engine 104 may be electrically and communicably coupled to the power control device 112 to receive operational power therefrom and to transmit to and receive data from the power control device 112. For example, the universal translator engine 104 may be configured to generate and/or transmit control data to the power control device 112 to control an operation of the light source 114 based on data received from the lighting control system 116 and/or the control devices 108.

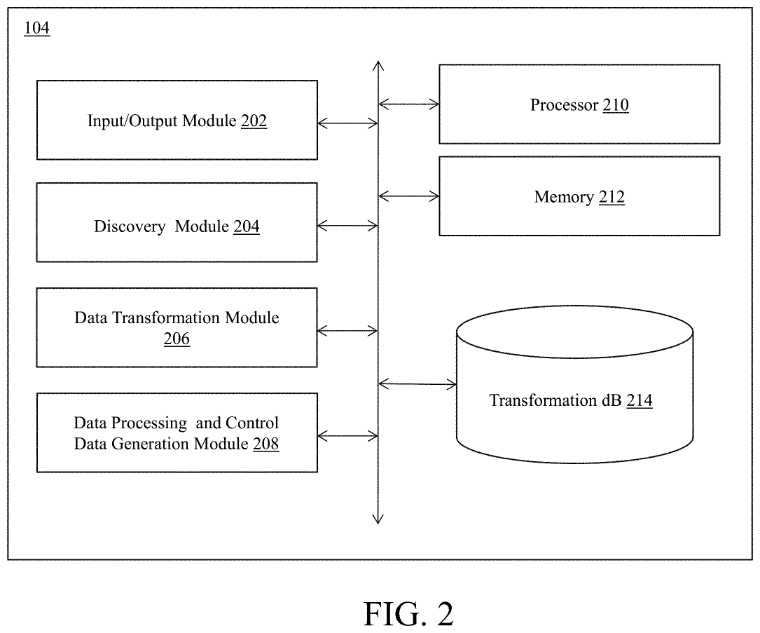

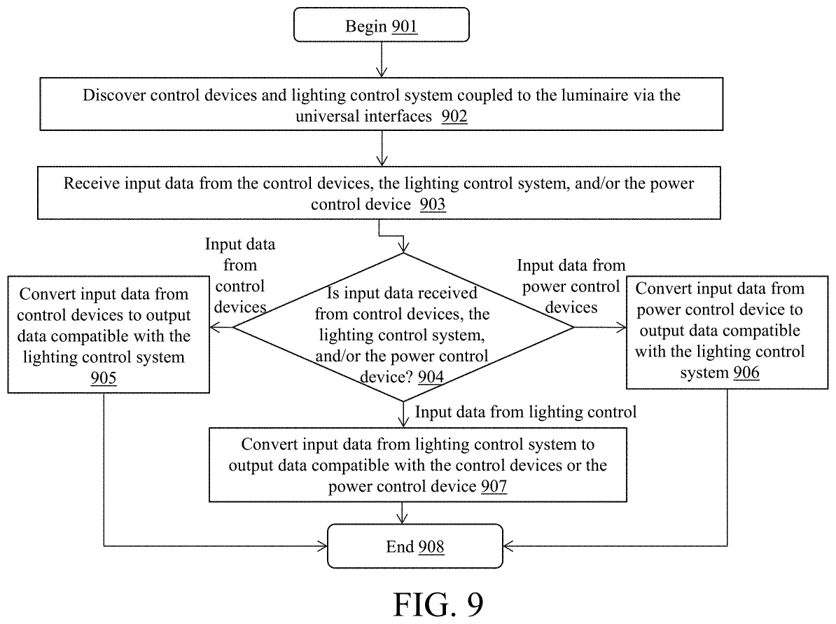

In particular, the universal translator engine 104 may be configured to transform input data received from the control devices 108 and the power control device 112 to an output data that is in a format that is compatible with the communication protocol of the building light control system 116 associated with the luminaire 102. The format of the input data that is received from the control devices 108 and the power control device 112 may be associated with a communication protocol that is different from the format of the output data that is associated with the communication protocol of the lighting control system 116. Converting the input data received from the control devices 108 and the power control device 112 to the output data having a format that is compatible with the lighting control system 116 enables communication and inter-operation between the power control device 112 of the luminaire 102, the control devices 108 coupled to the luminaire 102, and the lighting control system 116 of the luminaire 102 even though each of them have a different communication protocol. Further, the universal translator engine 104 may be configured to enable: (a) communication between two or more control devices 108 having different communication protocols; and/or (b) communication between the control devices 108 and the luminaire 102 having different communication protocols. Furthermore, the universal translator engine 104 may be configured to handle data processing associated with the control devices 108. Additionally, in some example embodiments, the universal translator engine 104 may include communication modules that provide additional functionality to the luminaire 102, such as Bluetooth, WiFi, etc. The universal translator engine 104 will be described below in greater detail in association with FIGS. 2 and 9.

Turning to FIG. 9, this figure illustrates a flow chart associated with an example operation of the universal translator engine 104. The example operation of the universal translator engine 104 will be described by making reference to FIG. 2 as needed. As illustrated in FIG. 2, the universal translator engine 104 may include an input/output module 202, a discovery module 204, a data transformation module 206, a data processing and control data generation module 208, a transformation database 214, a processor 210, and/or a memory 212. The processor 210 of the universal translator engine 104 may be a multi-core processor or a combination of multiple single core processors. Further, the universal translator engine 104 may include a memory 212 that is coupled to the processor 210. The memory 212 may be non-transitory storage medium, in one embodiment, and a transitory storage medium in another embodiment. The memory 212 may include instructions that may be executed by the processor 210 to perform operations of the universal translator engine 104. In other words, operations associated with the different modules 202-208 may be executed using the processor 210. Alternatively, each of the modules 202-208 may include corresponding instructions associated with routines and/or sub-routines that may be executed using the processor 210 to perform operations associated with said routines and/or sub-routines of the respective module 202-208.

Referring to FIG. 9, the example method of the universal translator engine 104 may begin at operation 901 and proceed to operation 902 where the universal translator engine 104 discovers the control devices 108 and the lighting control system 116 that are coupled to the luminaire 102 via the universal interfaces 106. In particular, in one example embodiment, a control device 108 and/or a lighting control system 116 that is coupled to the luminaire 102 via the universal interface 106 may transmit a connection signal to the universal translator engine 104 via the universal interface 106. The connection signal may include a device identifier, a device name, or any other identifying information associated with the control device 108. In another example embodiment, the discovery module 204 of the universal translator engine 104 may periodically transmit a discovery signal to each of the universal interfaces 106 to determine if any control device 108 and/or lighting control system 116 has been coupled to the universal interfaces 106. When a control device 108 and/or a lighting control system 116 is coupled to the universal interface 106, the control device 108 and/or the lighting control system 116 may respond to the discovery signal with an acknowledgement that comprises the identifying information associated with the control device 108 and/or the lighting control sy stem 116.

In either case, the input/output module 202 of the universal translator engine 104 receives the identifying information associated with the control devices 108 and/or the lighting control system 116 from the universal interfaces 106 to which the control devices 108 and/or the building lighting control system(s) 116 are coupled. Responsively, the input/output module 202 transmits the identifying information to the discovery module 204 that is configured to identify the control devices 108 and/or the lighting control system 116 coupled to the luminaire 102 based on the identifying information. The discovery module 204 may communicate with an external server to identify the control devices 108 and/or the lighting control system 116 or may identify the control devices 108 and/or the lighting control system 116 by comparing the identifying information against the transformation database 214 that may include information regarding various control devices 108 and/or building lighting control devices 116. Additionally, the transformation database 214 may include adapter or system converters 110 (also referred to as converter modules), e.g., DALI adapter, LWI adapter, EcoSystem adapter, etc., associated with communication protocols of various lighting control systems 116 and/or control devices 108. In some example embodiments, the adapter or system converters 110 associated with the communication protocols of various lighting control systems 116 and/or control devices 108 may be hardware adapters that can be coupled to the luminaire via the universal interfaces 106 as illustrated in FIG. 1.

Once the control devices 108 are discovered, in operation 903, the input/output module 202 may receive input data from the control devices 108, the lighting control system 116, and/or the power control device 112. In operation 904, the universal translator engine 104 determines whether the input data is received from the control devices 108, the power control device 112, or the lighting control system 116. Further, based on the input data, in operation 904, the universal translator engine 104 may determine the destination of the input data, i.e., where the input data is to be transmitted.

If the input data is received from a control device 108, then, in operation 905, the input/output module 202 transmits the received input data to the data transformation module 206. Further, the data transformation module 206 transforms or converts the input data having a first format associated with a first communication protocol of the control device 108 to an output data having a second format associated with a second communication protocol of the lighting control system 116 to enable a communication between the control device 108 and the lighting control system 116, provided the first and second communication protocols are different. Alternatively, the data transformation module 206 may transform or convert the input data having a first format associated with a first communication protocol of the control device 108 to an output data having a third format associated with a third communication protocol of the power control device 112 to enable communication between the control device 108 and the power control device 112, provided the first and third communication protocols are different. The output data in the second format may be communicated to the lighting control system 116 and the output data in the third format may be communicated to the data processing and control data generation module 206 to generate a control data for transmission to the power control device 112. In some embodiments, the data transformation module 206 may translate or convert the input data having a first format associated with a first communication protocol of the control device 108 to an output data having a fourth format that is associated with a fourth communication protocol of another control device 108 to enable communication between the control devices, provided the first and fourth communication protocols are different.

If the input data is received from the power control device 112, then in operation 906, the data transformation module 206 transforms or converts the input data having a third format associated with the third communication protocol of the power control device 112 to an output data having the second format associated with the second communication protocol of the lighting control system 116 to enable a communication between the power control device 112 and the lighting control system 116, provided the third and second communication protocols are different. Alternatively, the data transformation module 206 may transform or convert the input data having the third format associated with the third communication protocol of the power control device 112 to an output data having a first format associated with the first communication protocol of the control devices 108 to enable a communication between the power control device 112 and the control devices 108 having different communication protocols.

Similarly, if the input data is received from the lighting control system 116, then in operation 907, the data transformation module 206 may transform or convert the input data having the second format associated with the second communication protocol of the lighting control system 116 to an output data having a third format associated with the third communication protocol of the power control device 112 to enable a communication between the power control device 112 and the lighting control system 116, where the third and second communication protocols are different. Alternatively, the data transformation module 206 may transform or convert the input data having the second format associated with the second communication protocol of the lighting control system 116 to an output data having a first format associated with the first communication protocol of the control devices 108 to enable a communication between the lighting control system 116 and the control devices 108 having different communication protocols. The example method 900 of the universal translator engine 104 ends in operation 908.

In addition to transforming or converting the data from one format to another format, the universal translator engine 104 may be configured to process and analyze the data to generate the output data. For example, the universal translator engine 104 receives data comprising an amount of day light in a room, process the received data to determine how to adjust an intensity of light from an artificial light source in the room to conserve energy while still provide enough readable light to an occupant, and generates an output control signal for the power control device to adjust the intensity of the light emitted by the light source (e.g., daylight harvesting control). The output signal may be in a format that is compatible with the communication protocol associated with the power control device even though the input data was in a different format that is incompatible with the communication protocol associated with the power control device.

The data transformation module 206 may operate in concert with the adapter or system converters 110 stored in the transformation database 214 to convert the input data having one format associated with a communication protocol to an output data having a different format associated with another communication protocol to enable communication between the power control device 112, the control devices 108, and/or the lighting control system 116 having different communication protocols.

In some example embodiments, the data processing and control data generation module 206 may be configured to process data associated with the control devices 108 and generate control data for transmission to the power control device 112, the lighting control system 116, and/or other control devices. In one example, the processing modules that define the processing operations associated with the control devices 108 may be hard coded and stored in the transformation database 214. However, in other examples, the processing modules of the control devices 108 may be downloaded from external source once the control devices 108 are discovered. In one example, the data from an occupancy sensor may be received, translated if needed, and processed by the universal translator engine 104 to determine that an occupant has entered and room and responsively, the universal translator engine 104 generates and transmits control data to the camera coupled to the luminaire 102 (in a format compatible with the camera) to activate the camera and begin an image or video capture operation. In one or more example embodiments, any updates to the adapter or converter associated with communication protocols of various lighting control systems 116, control devices 108, and/or the power control device 112, or the processing modules associated with the control devices 108 may be transmitted (pushed) to the universal translator engine 104 via a wired or wireless network.

One of skill in the art can understand and appreciate that the luminaire 102 can include any appropriate lighting device, such as recessed luminaires, troffers, surface mount luminaires, wall wash luminaires, indoor and outdoor luminaires, etc., without departing from a broader scope of the present disclosure.

Further, the universal translator and accessory interface system may be made tamper-proof. As one example described previously, the universal interfaces 106 can receive interface cover members that conceal the universal interfaces and prevent damage. The interface cover members can be fastened over the universal interfaces 106 using any of a variety of fasteners, tabs, and clips. Furthermore, the interface cover members can have a locking mechanism that inhibits their removal from the universal interfaces and prevents tampering. In addition to the physical protection that interface cover members can provide, the universal translator and accessory interface system 101 can include software controls that prevent unapproved control devices from operating with the system. For example, a verification software algorithm can be installed in the universal translator engine 104 or the lighting control system 116. When a control device 108 is installed in a universal interface 106, the verification software algorithm can test the control device 108 to determine if it is approved for operation with the luminaire 102. If the control device 108 is not approved, the universal translator and accessory interface system 101 can respond by ceasing all communications with the unapproved control device 108. In this way, tampering with the luminaire 102 can be prevented with the verification software algorithm.

Although example embodiments are described herein, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A luminaire comprising:
a universal interface that is configured to removably and communicably couple a control device to the luminaire; and
a universal translator engine that is communicably coupled to a lighting control system of the luminaire,
wherein the universal translator engine is configured to transform input data that is received from the control device and associated with a first communication protocol to an output data that is compatible with the lighting control system and associated with a second communication protocol to enable communication between the control device and the lighting control system, and
wherein the first communication protocol is different from the second communication protocol.

2. The luminaire of claim 1, wherein the universal interface includes a micro-USB interface.

3. The luminaire of claim 1, wherein the universal translator engine is electrically coupled to a power control device of the luminaire to receive operational power therefrom, and wherein the universal translator engine is communicably coupled to the power control device.

4. The luminaire of claim 3, wherein the power control device is an LED driver.

5. The luminaire of claim 1, wherein the control device includes an audio transducer that is coupled to a surface of the luminaire to operate the luminaire as a speaker system.

6. The luminaire of claim 3, wherein the universal translator engine is configured to transform power input data that is received from the power control device and associated with a third communication protocol to a power output data that is compatible with the second communication protocol that is associated with the lighting control system to enable communication between the power control device and the lighting control system.

7. The luminaire of claim 3, wherein the universal translator engine and the universal interface are integrated into the power control device.

8. The luminaire of claim 3, wherein the universal translator engine is configured to transform the input data that is received from the control device and associated with the first communication protocol to a power output data that is compatible with a third communication protocol that is associated with the power control device to enable communication between the control device and the power control device.

9. The luminaire of claim 1:
wherein the luminaire further comprises another universal interface that is configured to removably and communicably couple another control device to the luminaire, and
wherein the universal translator is communicably coupled to the other universal interface and configured to transform the input data that is received from the control device and associated with the first communication protocol to another output data that is compatible with the other control device and associated with a fourth communication protocol to enable communication between the control device and the other control device, the first communication protocol being different from the fourth communication protocol.

10. The luminaire of claim 1, wherein the universal interface is integrated with the universal translator engine.

11. The luminaire of claim 1, wherein the universal translator engine is remote from and communicably coupled to the universal interface.

12. A luminaire comprising:
a first universal interface that is configured to removably and communicably couple a control device;
a second universal interface that is configured to removably and communicably couple a lighting control system to the luminaire;
a universal translator engine that is communicably coupled to the first universal interface and the second universal interface;
a power control device that is coupled to the universal translator engine; and
a light source that is coupled to the power control device,
wherein the power control device is configured to regulate and supply operational power to the light source and the universal translator engine, and
wherein the universal translator engine is configured to transform input data that is received from the control device and associated with a first communication protocol to an output data that is compatible with the lighting control system and associated with a second communication protocol to enable communication between the control device and the lighting control system, and
wherein the first communication protocol is different from the second communication protocol.

13. The luminaire of claim 12, wherein the first universal interface includes a micro-USB interface.

14. The luminaire of claim 12, wherein the power control device is an LED driver.

15. The luminaire of claim 12, wherein the control device includes an audio transducer that is coupled to a surface of the luminaire to operate the luminaire as a speaker system.

16. The luminaire of claim 12, wherein the universal translator engine is configured to transform power input data that is received from the power control device and associated with a third communication protocol to a power output data that is compatible with the second communication protocol that is associated with the lighting control system to enable communication between the power control device and the lighting control system.

17. The luminaire of claim 12:
wherein the luminaire further comprises a third universal interface that is configured to removably and communicably couple another control device to the luminaire.

18. The luminaire of claim 17, wherein the universal translator is communicably coupled to the third universal interface and configured to transform the input data that is received from the control device and associated with the first communication protocol to another output data that is compatible with the other control device and associated with a fourth communication protocol to enable communication between the control device and the other control device, the first communication protocol being different from the fourth communication protocol.

19. The luminaire of claim 12, wherein the power control device is coupled to at least one of the first universal interface and the third universal interface through which operational power may be supplied to the control device and the other control device, respectively.

20. The luminaire of claim 12, wherein the light source is a light emitting diode (LED).
